(19) United States
(12) Patent Application Publication
(10) Pub. No.: US 2006/0268996 A1
(43) Pub. Date: Nov. 30, 2006

(54) Error recovery using in band error patterns

(76) Inventors: Sumeet Singh Sethi, San Diego, CA (US); Vijayalakshmi R. Raveendran, San Diego, CA (US)

Correspondence Address: QUALCOMM INCORPORATED, 5775 MOREHOUSE DR., SAN DIEGO, CA, 92121, US

(21) Appl. No.: 11/432,953

(22) Filed: May 12, 2006

Related U.S. Application Data
(60) Provisional application No. 60/680,633, filed on May 13, 2005.
(60) Provisional application No. 60/789,273, filed on Apr. 4, 2006.

(51) Int. Cl. H04B 1/66; H04N 11/02; H04N 11/04; H04N 7/12

(52) U.S. Cl. 375/240.27

(57) ABSTRACT

A method and apparatus for decoding multimedia data are described. One method includes receiving an encoded bitstream, identifying the location of one or more erroneous bits in the bitstream, generating a marker indicating the one or more erroneous bits, and inserting the marker in the bitstream to create a modified bitstream. The method can further comprise decoding the modified bitstream using the marker to indicate the one or more erroneous bits. The method can further comprise initiating an error handling process when encountering the marker.

### CLAIM OF PRIORITY UNDER 35 U.S.C. §119

The present Application for patent claims priority to Provisional Application No. 60/680,633 entitled “Application Layer Interactions And Error Signaling” filed May 13, 2005, and claims priority to Provisional Application No. 60/789,273 entitled “Error Recovery Using In Band Error Patterns” filed Apr. 4, 2006, and assigned to the assignee hereof and hereby expressly incorporated by reference herein.

### I. BACKGROUND

1. Field

This invention relates to methods and apparatus for decoding real-time streaming media on handheld devices.

2. Background

Due to the explosive growth and great success of the Internet and wireless communication, as well as increasing demand for multimedia services, streaming media over the Internet and mobile/wireless channels has drawn tremendous attention. In heterogeneous Internet Protocol (IP) networks, video is provided by a server and can be streamed by one or more clients. Wired connections include dial-up, integrated services digital network (ISDN), cable, digital subscriber line protocols (collectively referred to as xDSL), fiber, local area networks (LAN), wide area networks (WAN) and others. The transmission mode can be either uni-cast or multi-cast.

Similar to the heterogeneous IP network is mobile/wireless communication. Transport of multimedia content over mobile/wireless channels is very challenging because these channels are often severely impaired due to multi-path fading, shadowing, inter-symbol interference, and noise disturbances. Some other reasons such as mobility and competing traffic also cause bandwidth variations and loss. The channel noise and the number of users being served determine the time-varying property of channel environments.

The demands of higher data rates and higher quality of service in both heterogeneous IP networks and mobile communication systems are growing rapidly. However, factors such as limited delay times, limited transmit power, limited bandwidth and multi-path fading continue to restrict the data rates handled by practical systems. In multimedia communications, particularly in error-prone environments, error resilience of the transmitted media is critical in providing the desired quality of service because errors in even a single decoded value can lead to decoding artifacts propagating spatially and temporally. Various encoding measures have been used to minimize errors while maintaining a necessary data rate, however all of these techniques suffer from problems with errors arriving at the decoder side.

There are numerous coding schemes directed towards minimizing the number of erroneous bits received by the decoder, or to efficiently handle the data corruption when it does occur. Channel coding, for example, Reed-Solomon coding, is used to improve the robustness of the source-coded data. Joint source-channel coding methodologies have been used to provide varying levels of error protection to source coded data with varying levels of importance or to enable rate adaptation of coded video data to available network bandwidth through partitioning and dropping data packets. This is because the common transport protocols do not deliver erroneous data to the source decoder.

Other techniques are also used for handling data errors. For example, source coding techniques such as reversible variable length coding (e.g., in MPEG-4) have been used for error recovery by decoding the packet in the reverse order when a packet having one or more bad or erroneous bits is received. There is a compromise in coding efficiency with source coding techniques, which translates to quality of decoded video for a given bit rate. Hybrid coding standards, such as MPEG-1, MPEG-2, MPEG-4 (collectively referred to as MPEG-x), H.261, H.262, H.263, and H.264 (collectively referred to as H.26x), use resynchronization points in the bitstream as the main method of handling errors at the decoder.

One cause of data loss in excess of the initial corruption is due to incorrect codeword emulation. The identification of the initial bit error position is not a trivial task and typically is not possible without a special design supporting the identification of bit error positions in a MAC layer or physical layer component. Hence, upon detecting bitstream corruption, the decoder will have to stop decoding and move forward in the bitstream to find the next resynchronization point, and in the process skipping a sizeable amount of potentially good data. Although emulation of a different codeword, which is the same length as the original (e.g., authentic) codeword might seem to be less of a problem with respect to the sequence of events described above, this is actually not the case. There are many ways in which this kind of an error may lead to failures in a decoder's correct bitstream interpretation. For example, in most current codecs there are objects in the bitstream (compression related parameters) whose values influence the syntax of the following portion of the bitstream. Hence, an incorrect value for such an object will lead to an incorrect bitstream interpretation.

Known error handling techniques can lead to inefficient decoder utilization as the decoder has a limited ability to handle bit errors, with dropping of packets and resynchronization being the most common solution. An improved method of handling bit errors that allows the decoder to continue to operate efficiently while sufficiently addressing erroneous bits in the multimedia data is needed.

### II. SUMMARY

Each of the inventive apparatuses and methods described herein has several aspects, no single one of which is solely responsible for its desirable attributes. Without limiting the scope of this invention, its more prominent features will now be discussed briefly. After considering this discussion, and particularly after reading the section entitled “Detailed Description” one will understand how the features of this invention provides improvements for multimedia data processing apparatuses and methods.

In one aspect, a method of processing multimedia data includes receiving an encoded bitstream, identifying erroneous data in the encoded bitstream, generating a marker associated with the erroneous data, and inserting the marker in the encoded bitstream to create a modified bitstream. The method can include using the marker to decode the modified bitstream. The method can also include initiating error handling if the marker is encountered during decoding.

In another aspect, an apparatus for processing multimedia data includes a communication component configured to receive an encoded bitstream of multimedia data, and a processor configured to identify the location of one or more erroneous bits in the bitstream, generate a marker indicating the one or more erroneous bits, and insert the marker in the bitstream to create a modified bitstream. The apparatus can be further configured to initiate error handling when encountering the marker during decoding. The apparatus can further include a decoder configured to decode the modified bitstream, wherein the decoder is further configured to use the marker to activate error handling when the marker is encountered during decoding.

In another aspect, an apparatus for processing multimedia data includes means for receiving an encoded bitstream, means for identifying the location of one or more erroneous bits in the bitstream, means for generating a marker indicating the one or more erroneous bits, and means for inserting the marker in the bitstream to create a modified bitstream.

Another aspect includes a computer readable medium for embodying a method for processing multimedia data, the method including receiving an encoded bitstream, identifying the location of one or more erroneous bits in the bitstream, generating a marker indicating the one or more erroneous bits, and inserting the marker in the bitstream to create a modified bitstream. The method can further include decoding the modified bitstream, wherein the marker is used during decoding to indicate the one or more erroneous bits. The method can further include initiating error handling when encountering the marker during decoding.

Another aspect includes a processor for processing multimedia data, the processor being configured to receive an encoded bitstream, identify the location of one or more erroneous bits in the bitstream, generate a marker indicating the one or more erroneous bits, and insert the marker in the bitstream to create a modified bitstream. The processor can also be configured to decode the modified bitstream, wherein the marker is used during decoding to indicate the one or more erroneous bits. The processor can be further configured to initiate error handling if the marker is encountered during decoding.

### III. BRIEF DESCRIPTION OF THE DRAWINGS

FIG. 1A is a block diagram of an example of a communications system for delivering streaming multimedia.

FIG. 1B is a block diagram of another example of a communications system for delivering streaming multimedia.

FIG. 2 is a block diagram of a multi-layer protocol stack used for dividing tasks in a transmitter and decoder.

FIG. 3 illustrates an example of packets that are passed as bitstream data to the decoder.

FIG. 4 is an example of a bitstream comprising a plurality of PLPs illustrated in the transport layer and in the application layer

FIG. 5 is a flow diagram of a method of decoding streaming multimedia data.

FIG. 6 is a block diagram of an apparatus for processing multimedia data.

### IV. DETAILED DESCRIPTION

In the following description, specific details are given to provide a thorough understanding of the embodiments. However, it will be understood by one of ordinary skill in the art that the embodiments may be practiced without these specific detail. For example, circuits may be shown in block diagrams in order not to obscure the embodiments in unnecessary detail. In other instances, well-known circuits, structures and techniques may be shown in detail in order not to obscure the embodiments.

Also, it is noted that the embodiments may be described as a process which is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, as disclosed herein, a “storage medium” may represent one or more devices for storing data, including read only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s) and/or data.

Furthermore, embodiments described herein may be implemented by hardware, software, firmware, middleware, microcode, or any combination thereof. For example, an encoder or a decoder may be incorporated on a processor in a receiver or a transmitter in hardware, firmware, middleware, or the decoder may be implemented in microcode or software that is executed on the processor, or a combination thereof. Alternatively, an encoder or a decoder may be implemented on a specialized decoder component other than a main processor of an apparatus, in hardware, firmware, middleware, or be implemented in microcode or software that is executed on the specialized decoder component. When implemented in software, firmware, middleware or microcode, the program code or code segments to perform the necessary tasks may be stored in a machine readable medium such as a storage medium. A processor may perform such necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

It should also be apparent to those skilled in the art that one or more elements of a device disclosed below may be rearranged without affecting the operation of the device. Similarly, one or more elements of a device disclosed below may be combined without affecting the operation of the device.

The following detailed description is directed to certain specific embodiments. However, the invention can be embodied in a multitude of different ways. Reference in this specification to “one embodiment” or “an embodiment” means that a particular feature, structure, or characteristic described in connection with the embodiment is included in at least one embodiment. The appearances of the phrase “in one embodiment,” “according to one embodiment,” or “in some embodiments” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Decoders in communication systems delivering streaming multimedia data can receive bitstreams that include one or more erroneous bits, such as corrupt or lost data. When the decoder encounters the erroneous data while decoding the bitstream, the decoding process is typically disrupted by the need to employ recovery processes and/or error handling processes. A method and apparatus to provide improved decoding capabilities to obviate, or at least minimize, the disruption caused by attempting to decode erroneous data in a multimedia bitstream is described herein. One method includes identifying the location of one or more erroneous bits in a multimedia bitstream received by a decoder, for example at a physical or transport layer level, and generating a marker indicating the one or more erroneous bits. The error marker is inserted in the bitstream to create a modified bitstream. The insertion of the error marker in the bitstream is “in-band” in the bitstream hence implying that the marker is sent along with the data originally received and not sent in any other layer or a side channel. For example, the error marker can be inserted in sequence into the data such that the marker is read as part of the bitstream itself. Thus, the error marker becomes part of the bitstream that is sent to the upper layers of the decoder, such as the application layer.

If the decoder encounters the marker while decoding the modified bitstream, it can initiate an error handling process, for example, error concealment, syntax checking, or simply drops it (e.g., skips or ignores the erroneous data). Providing the marker “in-band” enables efficient and faster decoding capabilities. In the following description, further details are given to provide a thorough understanding of the examples and aspects of the in-band error signaling patterns and its use to assist faster error recovery. However, it is understood by one of ordinary skill in the art that the examples may be practiced even if every detail of a process or device in an example or embodiment is not described or illustrated herein. For example, electrical components may be shown in block diagrams that do not illustrate every electrical connection or every electrical element of the component in order not to obscure the examples in unnecessary detail. In other instances, such components, other structures and techniques may be shown in detail to further explain the examples.

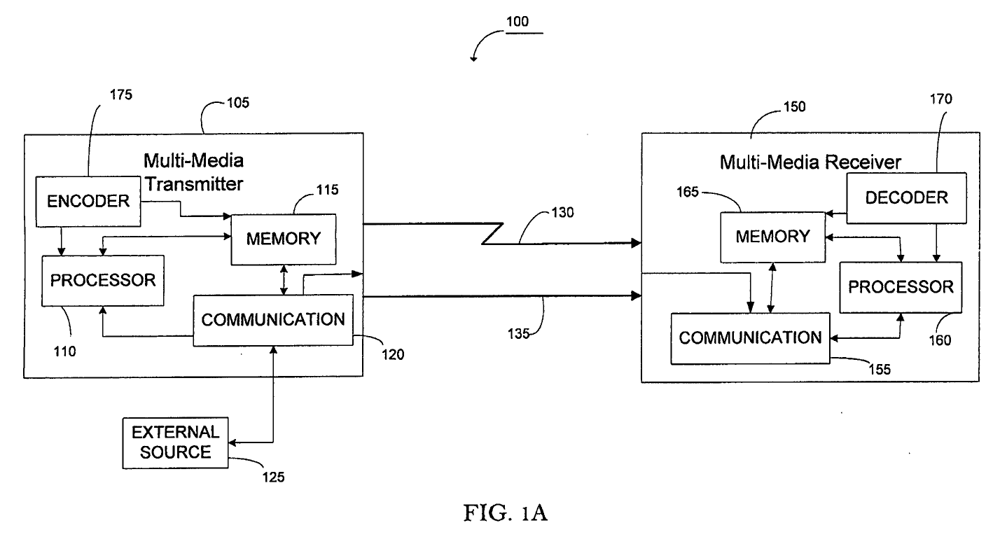

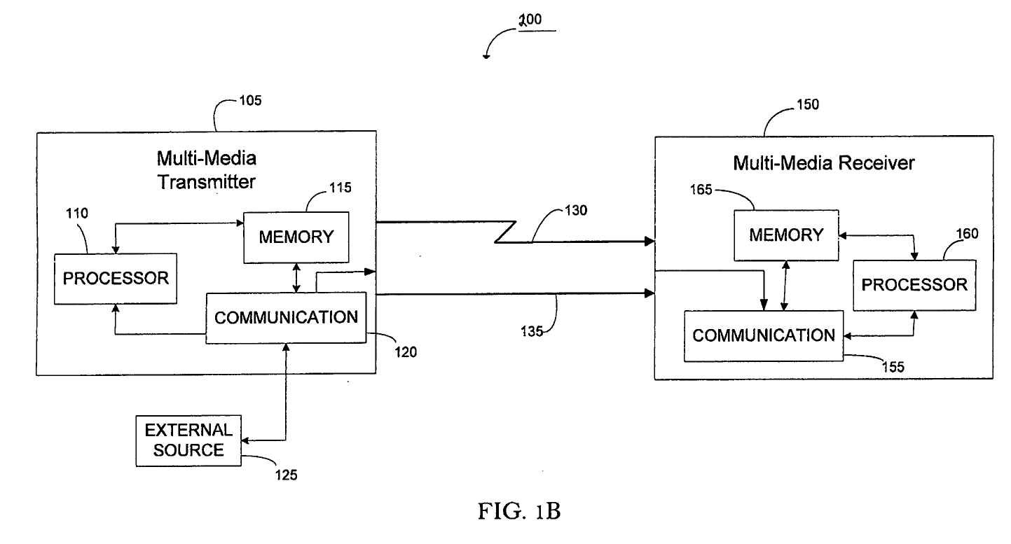

FIG. 1A is a block diagram of one example of a communications system 100 for delivering streaming multimedia data that can include the disclosed methods and apparatus of processing multimedia data. “Multimedia data,” as used herein, is a broad term that includes video data (which can include audio data), audio data, graphics, text data, picture or image data, or any combination thereof. “Video data” or “video” as used herein as a broad term, referring to sequences of images containing text or image information and/or audio data, and can be used to refer to multimedia data (e.g., the terms can be used interchangeably) unless otherwise specified.

Multimedia data communicated to a client device is typically compressed. Two video coding standards, known as MPEG-x and H.26x, describe data processing and manipulation techniques (referred to herein as hybrid coding) are well suited to the compression and delivery of video, audio and other information using fixed or variable length source coding techniques. The system 100 can use the above-referenced standards, and other hybrid coding standards and techniques. Illustratively, multimedia data can be compressed using intra-frame coding techniques (such as, for example, run-length coding, Huffman coding and the like) and inter-frame coding techniques (such as, for example, forward and backward predictive coding, motion compensation and the like). Audio data can be compressed in the MPEG-4 AAC, MP3, AMR and G.723 audio or voice compression standards.

The system 100 includes a multimedia transmitter 105 and a multimedia receiver 150. The transmitter 105 can include one or more memory components 115, and a processor 110 or multiple processors including any combination of a preprocessor (e.g., any type of central processor unit CPU such as an ARM), a digital signal processor (DSP), software, firmware, and hardware such as a video core, for distributing the modulation and encoding tasks associated with multimedia data. The transmitter 105 can also include an encoder 175 that encodes data for transmission to the receiver 150 using a coding standard, for example, MPEG-1, MPEG-2, MPEG-4 (collectively referred to as MPEG-x), H.261, H.262, H.263, or H.264 (collectively referred to as H.26x).

The transmitter 105 can also include a communication component 120 that acquires data from various sources, including an external source 125 (for example, the Internet, external memory, or a live video and/or audio feed). The transmitter 105 uses the communication component 120 to transmit the acquired data over a communication system to the receive 150. The communication system can be a wired network 135 such as telephone, cable, or fiber optic, or a wireless network 130. In the case of wireless communication systems, the network 130 can comprise, for example, a code division multiple access (CDMA or CDMA2000) communication system or alternately, the system can be a frequency division multiple access (FDMA) system, an orthogonal frequency division multiple access (OFDMA) system, a time division multiple access (TDMA) system such as GSM/GPRS (General Packet Radio Service)/EDGE (enhanced data GSM environment) or TETRA (Terrestrial Trunked Radio) mobile telephone technology for the service industry, a wideband code division multiple access (WCDMA), a high data rate (1xEV-DO or 1xEV-DO Gold Multicast) system, or in general any wireless communication system employing a combination of techniques.

The receiver 150 includes a communication component 155 and means for receiving data over the wireless network 130 and/or wired network 135, for example a radio frequency antenna or a network connection. The receiver 150 can also include a processor 160, or multiple processors including any combination of a preprocessor (e.g., any type of central processor unit CPU such as an ARM), a digital signal processor (DSP), software, firmware, and hardware such as a video core, for distributing the demodulation and decoding tasks associated with receiving and decoding data. The receiver 150 can also include a decoder 170 that decodes the received encoded bitstream using the applicable decoding standard that corresponds with the encoding standard used to generate the encoded data.

As illustrated in FIG. 1B, in some embodiments a processor 160 in the multi-media receiver 150 can perform the decoding tasks that were performed by the separate decoder 170 shown in FIG. 1A. The processor 160 can be configured with logic, for example, software, hardware, firmware or a combination thereof, to receive an encoded bitstream from the communication component 155, identify the location of one or more erroneous bits in the bitstream, generate a marker indicating the one or more erroneous bits, and insert the marker in the encoded bitstream to create a modified bitstream. The processor 160 can also be configured with logic to decode the modified bitstream, wherein the marker is used during decoding to indicate the one or more erroneous bits. The processor 160 can also be configured with logic to initiate an error handling if the marker is encountered during decoding. FIG. 1B also illustrates an embodiment where a processor 110 in the transmitter 105 can be configured to encode the bitstream and perform any other tasks performed by the encoder 175 shown in FIG. 1A.

Referring again to FIG. 1A, the receiver 150 also contains one or more memory components 165 for storing the received data and intermediate data in various stages of the demodulation/decoding process. In some embodiments, an ARM preprocessor (not shown) performs less complex tasks including unpacking (removing side information such as headers and signaling messages) and demultiplexing a plurality of bitstreams including audio, video and others. The ARM preprocessor also can perform bitstream parsing, error detection, error concealment, and variable length entropy decoding. In some such embodiments, a DSP performs expansion of VLC (variable length code) codewords, inverse zig-zag scan of video data to spatially locate pixel coefficients, inverse AC/DC prediction of pixel coefficients for MPEG-4 video (not a feature of H.264 due to context adaptive entropy coding), and audio decoding (e.g. MPEG-4 AAC, MP3, AMR or G.723). The video core may perform the more computationally complex tasks of video decoding comprising dequantization, inverse transformation, motion compensated prediction, and deblocking (a form of filtering to reduce edge artifacts between pixel block edges).

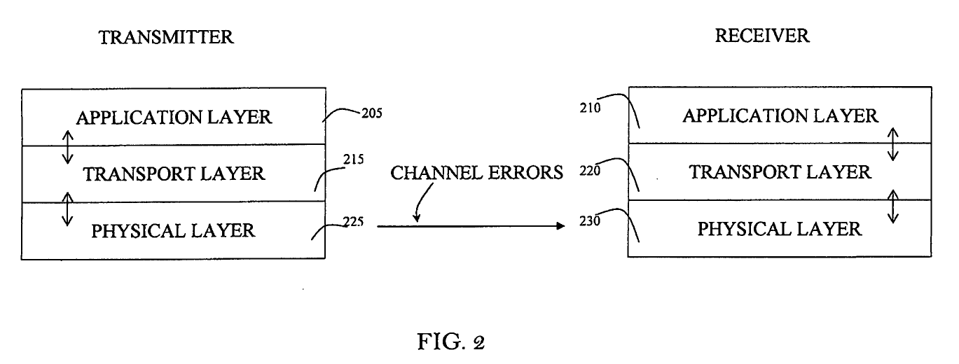

The receiver 150 contains error handling logic, for example, error detection, error concealment, and syntax checking. The error handling logic can be embodied in the receiver 150 in software, hardware or firmware. In particular, the receiver 150 includes error handling logic to identify one or more erroneous bits in a received encoded bitstream, generate an appropriate marker to indicate which bits in the bitstream are erroneous, and insert the marker “in-band” into the bitstream. Generation, insertion and use of such a marker is described further in reference to FIGS. 2-6. In some embodiments, the error handling logic can also identify and mark as a whole erroneous packets containing erroneous bits. All or a portion of the error handling logic can reside on the decoder 170, the processor 160, in one or more memory components 165, or in another logical device in the receiver 150. One or more elements may be added to communications system 100 without deviating from the scope of this invention.

FIG. 2 is a block diagram of a multi-layer protocol stack that can be used for dividing tasks in the transmitter 105 and receiver 150 illustrated in FIG. 1B. The protocol stack includes application layers 205, 210, transport layers 215, 220, and physical layers 225, 230 for a transmitter side and a receiver side, respectively, which correspond to the transmitter 105 and receiver 150 illustrated in FIG. 1B. In some embodiments, these may be parts of a standard OSI layer architecture. However, the layers are not limited to the OSI architecture. The application layer 205 and 210 in transmitter 105 and receiver 150, respectively, may include multiple applications such as, for example video or audio encoders and/or decoders. Some embodiments may include multiple streams of information that are meant to be decoded simultaneously. In these cases, synchronization tasks of the multiple streams may also be performed in the application layers 205 and 210. The application layer 205 may provide encoded timing information in the bitstream that is transmitted over the wireless network 130 or wired network 135. The application layer 210 can parse the multiple streams of information such that the associated applications decode them simultaneously or nearly so. Those of skill in the art will recognize these layers and be familiar with the allocation of various tasks among them. Those of skill in the art will also recognize that in some embodiments, the layers shown in FIG. 2 may be shown in further detail to include a synchronization layer, a stream or medium access (MAC) control layer, and/or one or more layers of the described layers.

The transport layer 215 and physical layer 225 of transmitter 105 may include various schemes to provide for error resiliency. Error prone channels such as wireless network 130 and/or wired network 135 (FIG. 1B) may introduce errors into the bitstream received by receiver 150. Error resiliency processes may include one or error control coding schemes, interleaving schemes and other such schemes. The transport layer 220 and a physical layer 230 of receiver 150 may include the corresponding error decoding that enable detection and correction of errors. The transport layer 220 may perform error analysis and/or detection, for example, forward error correction and outer coding. Physical layer 230 can also perform error analysis and/or detection including. Some errors that are introduced by wireless network 130 or wired network 135 may not be correctable by the transport layer 220 or the physical layer 230. For those errors that can be identified but are not correctable, and where solutions such as requesting retransmission of erroneous components may not be feasible, the location of erroneous bits and the number of erroneous bits may indicated by a marker which is inserted “in-band” in the bitstream and sent up to the application layer 210.

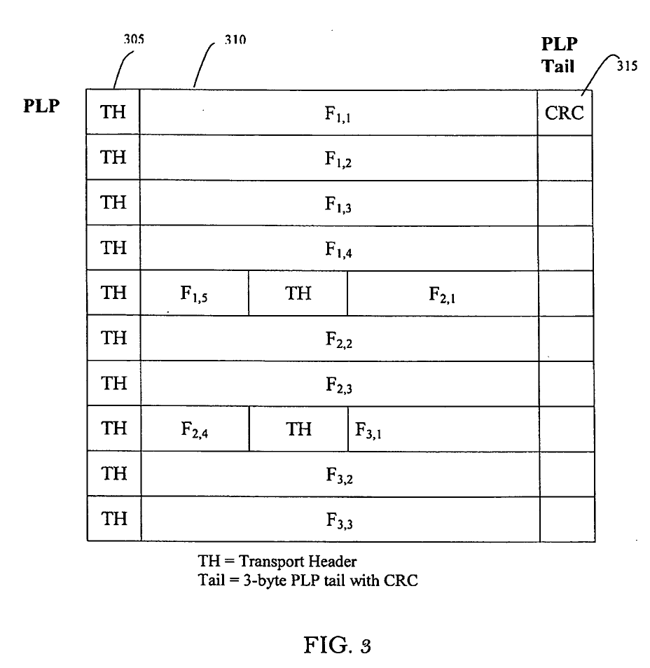

FIG. 3 illustrates an example of physical layer packets (or “PLPs”) that are passed as bitstream data to the receiver 150. Each packet has a transport header portion 305, a body portion 310 containing the encoded multimedia data, and a tail portion 315 containing an error check code, for example, a cyclic redundancy checksum (“CRC”). If a packet containing erroneous data, e.g., one or more erroneous bits (a “bad” PLP) is detected, for example, by error detection logic in the physical layer or the transport layer of the receiver, the transport header is marked to indicate that one or more bits in the are erroneous (e.g., bad). An error pattern marker is placed “in-band” with the slice header or slice data information, resulting in a modified bitstream, which is sent on to the application layer. When the application layer components of the receiver encounter the error pattern marker in the bitstream, the decoder can take action to address the erroneous marked PLP, or drop the bad PLP and continue decoding from the next PLP. In some embodiments, the decoder activates syntax checking or other error checking functionality when it encounters the error marked PLP. In some embodiments, when the decoder encounters the error marked PLP it activates error concealment to handle or mask regions corresponding to the erroneous bits.

In some embodiments, the syntax for the error pattern may be depicted in hexadecimal as follows:

00 00 01 18<error pattern length byte><bad bitstream length>

where “00 00 01 18” is the start code prefix to signal that its inserted data within the ongoing NAL unit. The “error pattern length byte” signifies the number of bytes to read after this byte for reading out the error pattern NAL. The “bad bitstream length” signifies the length of the erroneous bits. In some embodiments, the “bad bitstream length” component is set to the length of the current packet, indicating that all the bits in the packet are erroneous. In some embodiments, the start code prefix can be “00 00 01 24”. In general, start code prefix is chosen such that the sync byte consisting of “00 00 01” is followed by some reserved or unspecified yet normative part of the compression specification such that the decoder that conforms to such specification handle the error pattern gracefully (e.g., without crashing).

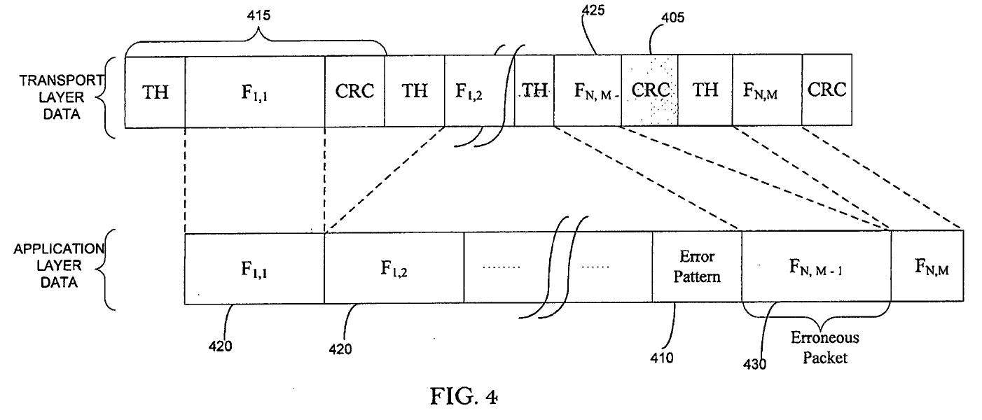

FIG. 4 is an example of bitstream data comprising a plurality of PLPs illustrated in the transport layer and in the application layer. The transport layer data illustrates the bitstream data as having numerous packets 415 each including a transport header (“TH”), packet data as referenced by an application packet ID—F_{N,M} (where _{N,M} indicate M^{th} packet of video frame N), and a packet (PLP) tail that contains a cyclic redundancy checksum (“CRC”). The CRC provides a parity check on the data constituting the transport header and the application packet data. When the CRC does not match the parity bits generated for this data at the receiving side (e.g., the decoder side), e.g., application packet 425, the CRC is marked as failed in the transport header by a particular error pattern that the decoder logic will recognize and interpret to determine which bits are erroneous. For example, CRC 405 is illustrated as marked erroneous. In some embodiments, the error pattern insert 410 can mark the entire packet as erroneous. In some embodiments, the error pattern insert 410 indicates a particular number of bits are erroneous.

The application layer data illustrates the bitstream data received from the transport layer as containing numerous packet data 420, each illustrated by a different application packet ID. The application layer data no longer contains the transport header or the CRC field. The packet data exists as a stream of “good” data to be decoded unless otherwise marked. Packet 430 corresponds to the packet in the transport layer data that has a bad CRC or any other erroneous information (e.g., bad bits). To indicate that packet 430 includes one or more erroneous bits, an error pattern marker is inserted before packet 430 “in-band” with the bitstream. The decoder is configured with logic to recognize the error pattern marker if it is encountered, and can then either drop the data or activate error handling logic. Inserting the error pattern marker “in-band” allows the decoder to process the data with out relying on any other information that is not “in-band,” which results in faster decoding. In some embodiments, when a marker is encountered the indicated “bad” data bits can be handed off to another process for error correction or error concealment.

It is noted that some embodiments may be described as a process, which is depicted as a flowchart, a flow diagram, a structure diagram, or a block diagram. Although a flowchart may describe the operations as a sequential process, many of the operations can be performed in parallel or concurrently and the process can be repeated. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

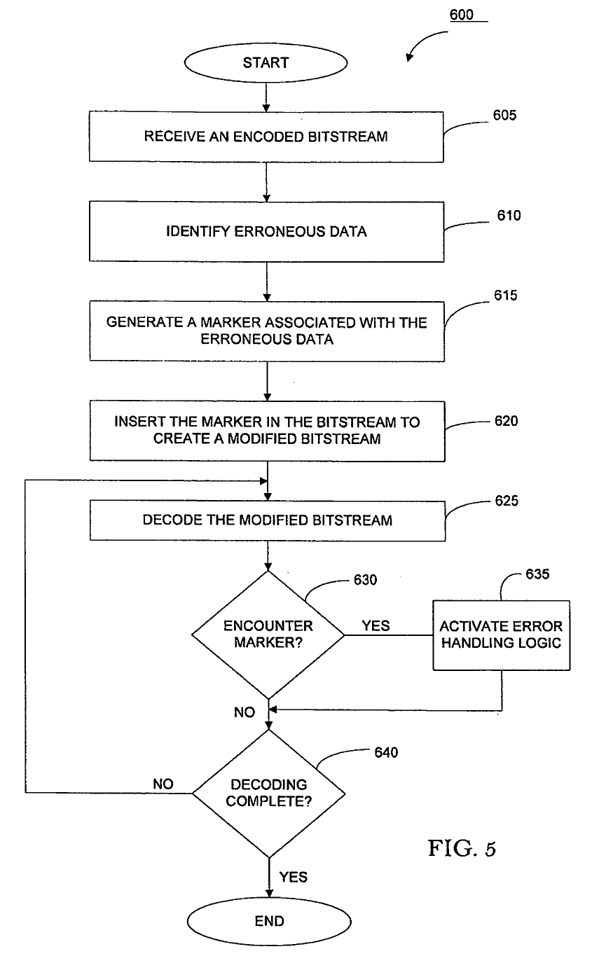

One embodiment described as a process is shown in FIG. 5, which is a flow diagram of a process 600 for decoding streaming multimedia data. At state 605 the process 600 receives an encoded bitstream. The bitstream can be received from, for example, the transmitter 105 via the wired network 135 or the wireless network 130. At state 610, the process 600 identifies the location of one or more erroneous bits in the bitstream. In some embodiments, erroneous bits can be identified by error handling logic implemented in the physical layer 230 or the transport layer 220 of a decoder. In other embodiments, the erroneous bits can be identified by a process that preprocesses the bitstream before it is decoded by a process in a decoder (for example, a process in the application layer 210 of the receiver 150). Once the process 600 identifies one or more erroneous bits in the bitstream, it generates a marker indicating the erroneous bits at state 615. For example, the marker can indicate the presence of erroneous bits, the location of the erroneous bits or the location of the first erroneous bits in a set of erroneous bits, and/or indicate the length of the erroneous bits in the bitstream (e.g., the number of erroneous bits or the location of the last erroneous bit). At state 620, the process 600 inserts the error marker in the bitstream to create a modified bitstream. The marker is inserted “in-band” in the bitstream. In some embodiments, the error marker is inserted immediately preceding the erroneous data. The error marker can include, for example, a start code prefix to signal its presence in the modified bitstream, information indicating the length of the error pattern, and/or information indicating the length of the erroneous bits. The marker can include a predetermined error pattern that the decoder knows indicates the presence of one or more erroneous bits. In other embodiments, the error pattern can be inserted in the transport header preceding the erroneous bits of a packet.

Optionally, the process 600 can also include decoding the modified bit stream, for example, at state 625 of the process 600, the modified bitstream is decoded in accordance with the applicable standards that were used to encode the bitstream. During the decoding process, an error marker may be encountered. In state 630, if the process 600 encounters an error marker, error handling logic is activated to handle the erroneous bits. The error handling logic can be, for example, syntax checking, error correction, error concealment, or ignoring (e.g., dropping) the erroneous bits. In some embodiments, the decoder can activate two or more error handling processes upon encountering the marker. After activating the error handling logic at state 635, or if an error marker is not encountered, decoding continues. At state 640 the process 600 determines whether decoding of the modified bitstream is complete. If not, process 600 continues at state 625 to decode the modified bitstream. When decoding is complete, process 600 ends.

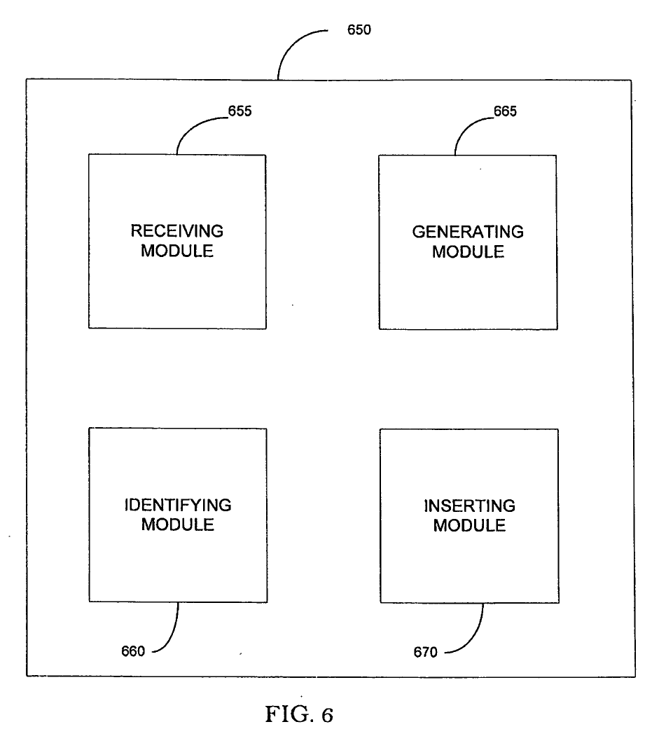

The methods and apparatus described herein can be employed in various implementations. FIG. 6 illustrates one such example of an apparatus 650 for processing multimedia data, apparatus for processing multimedia data apparatus 650 comprise means for receiving an encoded bitstream, means for identifying the location of one or more erroneous bits in the bitstream, means for generating a marker indicating the one or more erroneous bits, and means for inserting the marker in the bitstream to create a modified bitstream. As illustrated in FIG. 6, the receiving means may comprise receiving module 655. The identifying means may comprise an identifying module 660. The generating means may comprise a generating module 665. The inserting means may comprise an inserting module 670. In some embodiments, the decoder 170 may be implemented by one or more of the identifying module 660, the generating module 665 and the inserting module 670. Also, optionally, the apparatus may further comprise means for decoding the modified bitstream, where the marker is used during decoding to indicate the one or more erroneous bits. The apparatus may also comprise means for initiating an error handling process when encountering the marker during decoding. The inserting means may comprise a processor configured to insert the marker in the bitstream to create a modified bitstream. In some embodiments of the apparatus, the inserting means may be configured to insert the marker in the bitstream such that the marker becomes part of the bitstream. The decoding means of the apparatus may comprise a processor configured to decode the modified bitstream.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill would further appreciate that the various illustrative logical blocks, modules, and algorithm steps described in connection with the examples disclosed herein may be implemented as electronic hardware, firmware, computer software, middleware, microcode, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosed methods.

The various illustrative logical blocks, components, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an Application Specific Integrated Circuit (ASIC). The ASIC may reside in a wireless modem. In the alternative, the processor and the storage medium may reside as discrete components in the wireless modem.

The previous description of the disclosed examples is provided to enable any person of ordinary skill in the art to make or use the disclosed methods and apparatus. Various modifications to these examples will be readily apparent to those skilled in the art, and the principles defined herein may be applied to other examples and additional elements may be added without departing from the spirit or scope of the disclosed method and apparatus.

It should be noted that the foregoing embodiments are merely examples and are not to be construed as limiting the invention. The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A method of processing multimedia data, comprising:
receiving an encoded bitstream;
identifying erroneous data in the encoded bitstream;
generating a marker associated with the erroneous data; and
inserting the marker in the encoded bitstream to create a modified bitstream.

2. The method of claim 1, further comprising using the marker to decode the modified bitstream.

3. The method of claim 2, further comprising initiating an error handling process if the marker is encountered during decoding.

4. The method of claim 3, wherein the error handling process comprises syntax checking, dropping the erroneous data, or error concealment.

5. The method of claim 1, wherein the marker is inserted in the encoded bitstream preceding the erroneous data.

6. The method of claim 1, wherein a packet loss ratio is determined based on the marker.

7. The method of claim 1, wherein the marker comprises a start code prefix to signal its presence in the modified bitstream.

8. The method of claim 7, wherein the marker comprises a numerical value associated with how many byte(s) are used in the marker after the start code prefix.

9. The method of claim 1, wherein the marker comprises a field comprising at least one byte of information indicating a length of the erroneous data.

10. The method of claim 1, wherein the marker is inserted in the bitstream such that the marker forms part of the bitstream itself.

11. The method of claim 1, wherein the marker conforms to a compression specification that the received encoded bitstream conforms to.

12. The method of claim 2, wherein the marker is inserted in the bitstream such that the marker becomes part of the bitstream, and wherein the bitstream with the inserted marker is decoded by an upper layer of a decoder.

13. The method of claim 12, wherein the upper layer comprises an application layer.

14. An apparatus for processing multimedia data, comprising:
a communication component configured to receive an encoded bitstream of multimedia data; and
a processor configured to identify the location of one or more erroneous bits in the bitstream, generate a marker indicating the one or more erroneous bits, and insert the marker in the bitstream to create a modified bitstream.

15. The apparatus of claim 14, wherein the processor is further configured to initiate error handling when encountering the marker during decoding.

16. The apparatus of claim 14, further comprising a decoder configured to decode the modified bitstream, wherein the decoder is configured to use the marker to activate error handling when the marker is encountered during decoding.

17. The apparatus of claim 14, wherein the processor is further configured with a decoding process to decode the modified bitstream, wherein the decoding processing uses the marker to activate error handling when the marker is encountered during decoding.

18. The apparatus of claim 17, wherein the error handling comprises syntax checking, dropping the erroneous data, or error concealment.

19. The apparatus of claim 14, wherein the marker is inserted in a transport header packet of the encoded bitstream preceding the erroneous bits.

20. The apparatus of claim 14, wherein the marker comprises an error pattern.

21. The apparatus of claim 19, wherein a packet loss ratio is determined based on the error pattern.

22. The apparatus of claim 20, wherein the error pattern comprises a start code prefix to signal its presence in the modified bitstream.

23. The apparatus of claim 20, wherein the bitstream is passed to a decoder in the form of packets that comprise a transport header, and wherein the error pattern is inserted “in-band” into the transport header.

24. The apparatus of claim 20, wherein the error pattern comprises information indicating the error pattern length.

25. The apparatus of claim 20, wherein the error pattern comprises information indicating the length of the erroneous bits.

26. The apparatus of claim 14, wherein the processor is configured to insert the marker in the bitstream such that the marker is read as part of the bitstream itself.

27. The apparatus of claim 14, further comprising a decoder configured to decode the bitstream, wherein the processor is configured to insert the marker in the bitstream such that the marker becomes part of the bitstream, and the decoder comprises an upper layer for decoding the bitstream.

28. The apparatus of claim 27, wherein the upper layer comprises an application layer.

29. An apparatus for processing multimedia data, comprising:
means for receiving an encoded bitstream;
means for identifying the location of one or more erroneous bits in the bitstream;
means for generating a marker indicating the one or more erroneous bits; and
means for inserting the marker in the bitstream to create a modified bitstream.

30. The apparatus of claim 29, further comprising means for decoding the modified bitstream, wherein the marker is used during decoding to indicate the one or more erroneous bits.

31. The apparatus of claim 30, further comprising means for initiating an error handling process when encountering the marker during decoding.

32. The apparatus of claim 29, wherein the receiving means comprises a receiver.

33. The apparatus of claim 29, wherein the identifying means comprises a processor configured to identify the location of one or more erroneous bits in the bitstream.

34. The apparatus of claim 29, wherein the generating means comprises a processor configured to generate a marker indicating the one or more erroneous bits.

35. The apparatus of claim 29, wherein the inserting means comprises a processor configured to insert the marker in the bitstream to create a modified bitstream.

36. The apparatus of claim 29, wherein the inserting means is configured to insert the marker in the bitstream such that the marker is read as part of the bitstream itself.

37. The apparatus of claim 30, wherein the inserting means is configured to insert the marker in the bitstream such that the marker becomes part of the bitstream, and the decoding means comprises an upper layer for decoding the modified bitstream using the inserted marker.

38. The apparatus of claim 37, wherein the upper layer comprises an application layer.

39. A computer readable medium for embodying a method for processing multimedia data, the method comprising:
receiving an encoded bitstream;
identifying the location of one or more erroneous bits in the bitstream;
generating a marker indicating the one or more erroneous bits; and
inserting the marker in the bitstream to create a modified bitstream.

40. The computer readable medium of claim 39, further comprising decoding the modified bitstream, wherein the marker is used during decoding to indicate the one or more erroneous bits.

41. The computer readable medium of claim 39, further comprising initiating an error handling process when encountering the marker during decoding.

42. A processor for processing multimedia data, the processor being configured to receive an encoded bitstream, identify the location of one or more erroneous bits in the bitstream, generate a marker indicating the one or more erroneous bits; and insert the marker in the bitstream to create a modified bitstream.

43. The processor of claim 42, wherein the processor is further configured to decode the modified bitstream, wherein the processor is configured to use the marker during decoding to indicate the one or more erroneous bits.

44. The processor of claim 42, wherein the processor is further configured to initiate error handling when the marker is encountered during decoding.

45. The processor of claim 42, wherein the processor is further configured to insert the marker in the bitstream such that the marker is read as part of the bitstream itself.

46. The processor of claim 43, wherein the processor is further configured to insert the marker in the bitstream such that the marker becomes part of the bitstream, and to decode the bitstream using an application layer.

47. An apparatus for processing multimedia data, comprising a decoder configured to identify the location of one or more erroneous bits in an encoded bitstream, generate a marker indicating the one or more erroneous bits, and insert the marker in the bitstream to create a modified bitstream.

48. The apparatus of claim 47, further comprising a communication component configured to receive an encoded bitstream of multimedia data and provide the encoded bitstream to the decoder.

49. The apparatus of claim 47, wherein the decoder is further configured to initiate error handling when encountering the marker during decoding.

50. The apparatus of claim 47, wherein the marker is inserted in a transport header packet of the encoded bitstream preceding the erroneous bits.

51. The apparatus of claim 47, wherein the marker comprises an error pattern.

52. The apparatus of claim 51, wherein the error pattern comprises a start code prefix to signal its presence in the modified bitstream.

53. The apparatus of claim 47, wherein the encoded bitstream comprise packets each comprising a transport header, and wherein the marker is inserted “in-band” into the transport header.

54. The apparatus of claim 47, wherein the marker comprises information indicating the marker length.

55. The apparatus of claim 47, wherein the marker comprises information indicating the length of the erroneous bits.

56. The apparatus of claim 47, wherein the processor is configured to insert the marker in the bitstream such that the marker is read as part of the bitstream itself.
